(19) United States
(12) Patent Application Publication
(10) Pub. No.: US 2025/0117852 A1
(43) Pub. Date: Apr. 10, 2025

(54) Method And System For Management Of An Investment Portfolio Strategy For A Plurality Of Investors In A Fund

(71) Applicant: Prometheus Asset Management Limited, Limassol (CY)

(72) Inventors: Grigorios PAPAMANOUSAKIS, Edinburgh (GB); Dimitrios PAPADOPOULOS, Sai Kung (HK); Alessandro FACCHIN, Fiume Veneto (IT); Alexandros ALEXANDRAKIS, Athens (GR); Michael Anthony FLYNN, Brentford (GB); Xenophon GOUMAS, Athens (GR); Nikolaos MAGOULAS, Athens (GR); Sevastos MASTROGIORGIS, Kos (GR); Georgios MINADAKIS, Edinburgh (GB); Ioannis Thanos PAPAKONSTANTINOU, Galatsi (GR); Kostyantyn SHUNDYAK, London (GB)

(21) Appl. No.: 18/294,637

(22) PCT Filed: Aug. 2, 2022
(86) PCT No.: PCT/EP2022/071735

§ 371 Date: Feb. 2, 2024

(30) Foreign Application Priority Data
Aug. 2, 2021 (SG) 10202108417V

(51) Int. Cl. G06Q 40/06

(52) U.S. Cl. CPC G06Q 40/06

(57) ABSTRACT

A method for management of an investment portfolio strategy for a plurality of investors in a fund is provided, the method comprising the steps of: review of the strategy of an individual investor of the plurality of investors by a portfolio manager module; determine an individual strategy for the individual investor by the portfolio manager module; process the determined individual strategy for the individual investor; collate net fund portfolio trades by the portfolio manager module; calculate net fund margin requirements by the portfolio manager module in combination with a broker module; calculate and execute net margin requirements per investor by the portfolio manager module in combination with a custodial account holder module; generate and execute trade orders by the broker module; and calculate the expected profit/loss.

### CROSS-REFERENCE TO RELATED APPLICATIONS

This application claims priority of Singapore Patent Application number SG10202108417V, filed on 2 Aug. 2021. The entire disclosure of the Singapore Patent Application number SG10202108417V is hereby incorporated herein by reference

### BACKGROUND OF THE INVENTION

The invention relates to a method for management of an investment portfolio strategy for a plurality of investors in a fund. The invention further relates to an investment portfolio strategy system for management of an investment portfolio strategy for a plurality of investors in a fund.

Portfolio optimisation is the process of selecting a set of financial instruments and determining their desired investment weights in the portfolio in a manner that satisfies a set of objective criteria. The pioneering works of Markowitz [Harry Markowitz. Portfolio selection. The Journal of Finance, 7 (1):77-91, 1952] and Ross [4 Stephen A Ross. The arbitrage theory of capital asset pricing. Journal of Economic Theory, 13 (3):341-360, 1976] identified the objective functions which link the level of a portfolio's expected return with the volatility of its constituents and/or their historical performance. In addition to this, practitioners have incorporated real-life constraints of portfolio management (e.g., cost of transactions, minimum and maximum limits on positions in s single asset, sector, discrete investment horizons, etc.) into these approaches, and thoroughly validated their predictions.

Modifications of the “optimal” portfolio composition may be triggered by market changes or requested by the investors themselves, e.g., through requested updates to their investing preferences, the amount of assets under management, or the desired level of risk. Whereas most standard portfolio optimization methods assume a static set of investors' choices, this approach is not suitable for portfolios with a large number of investors continuously updating their investment preferences. For such portfolios, it is more appropriate to model the combined investors' preferences on the total portfolio level as a stochastic process.

Another important parameter for an optimisation algorithm of such portfolios (i.e., with a large number of investors) is runtime: preferences of the investors should be updatable at arbitrary time, and in particular upon reviewing the achieved results. Although some constraints can make a portfolio optimization an NP-hard problem [T.-J. Chang, N. Meade, J. E. Beasley, and Y. M. Sharaiha. Heuristics for cardinality constrained portfolio optimisation. Computers Operations Research, 27 (13):1271-1302, 2000], practical implementations may be able to efficiently approximate an optimized investment strategy.

Therefore, there is a need for an optimized investment portfolio strategy method and system for portfolios with multiple participating investors.

### SUMMARY OF THE INVENTION

In view of the known technologies and according to a first aspect of the present disclosure, a method for management of an investment portfolio strategy for a plurality of investors in a fund is provided, comprising the steps of: review of the strategy of an individual investor of the plurality of investors by a portfolio manager module: determine an individual strategy for the individual investor by the portfolio manager module: process the determined individual strategy for the individual investor: collate net fund portfolio trades by the portfolio manager module: calculate net fund margin requirements by the portfolio manager module in combination with a broker module: calculate and execute net margin requirements per investor by the portfolio manager module in combination with a custodial account holder module; generate and execute trade orders by the broker module; and calculate the expected profit/loss.

In one aspect, the method further comprises the step of allocating profit/loss at a fund level.

In another aspect, the method further comprises the step of allocating profit/loss per investor.

In one aspect, the method further comprises the step of applying money market transactions.

In another aspect, the method further comprises the step of recalculating and re-allocating the margin requirements for all investors in the fund dynamically and at arbitrary times due to changes in their investment strategy or external market events.

In one further aspect, the method further comprises the step of recalculating and re-allocating the margin requirements for all investors in the fund dynamically after model changes and market trades performed by the fund manager.

In one further aspect, the method further comprises the step of keeping track of all system changes.

According to a second aspect of the present disclosure, an investment portfolio strategy system for management of an investment portfolio strategy for a plurality of investors in a fund is provided, wherein the system comprises a portfolio manager module for reviewing of the strategy of an individual investor of the plurality of investors, wherein the portfolio manager module determines an individual strategy for the individual investor and processes the determined individual strategy for the individual investor, and wherein the portfolio manager module collates net fund portfolio trades, wherein the portfolio manager module calculates net fund margin requirements in combination with a broker module, wherein the portfolio manager module calculates and executes net margin requirements per investor in combination with a custodial account holder module, wherein the broker module generates and executes trade orders, and wherein the investment portfolio strategy system calculates the expected profit/loss.

In one further aspect, the system is configured such that the portfolio manager module allocates profit/loss at a fund level.

In one further aspect, the system is configured such that the portfolio manager module allocates profit/loss per investor.

In another aspect, the system is configured such that the portfolio manager module applies money market transactions.

In one further aspect, the system is configured such that the portfolio manager module recalculates and re-allocates the margin requirements for all investors in the fund dynamically and at arbitrary times due to changes in their investment strategy or external market events.

In one further aspect, the system is configured such that the portfolio manager module recalculates and re-allocates the margin requirements for all investors in the fund dynamically after model changes and market trades performed by the fund manager.

In another aspect, the system is configured such that the system keeps tracking of all system changes.

### BRIEF DESCRIPTION OF THE DRAWINGS

The invention will now be explained in more detail with reference to the following figures. It will be understood that the aspects of the invention described in the figures are only examples and do not limit the protective scope of the claims in any way. The invention is defined by the claims and their equivalents. It will be understood that features of one aspect of the invention can be combined with a feature of a different aspect or aspects of the invention. This invention becomes more obvious when reading the following detailed descriptions of some examples as part of the disclosure under consideration of the enclosed drawings. Referring now to the attached drawings which form a part of this disclosure.

FIG. 1 shows a flowchart of the method for management of an investment portfolio strategy for a plurality of investors in a fund according to the first aspect of the present invention.

FIG. 2 shows the system for management of an investment portfolio strategy for a plurality of investors in a fund according to the second aspect of the present invention.

### DETAILED DESCRIPTION OF THE INVENTION

The object of the present invention is fully described below using examples for the purpose of disclosure, without limiting the disclosure to the examples. The examples present different aspects of the present invention. To implement the present technical teaching, it is not required to implement all of these aspects combined. Rather, a person skilled in the art will select and combine those aspects that appear sensible and required for the corresponding application and implementation.

A portfolio management system 200 serves a plurality of different participants. An individual investor 50 specifies their investment choices in terms of investment strategies. There is a wide degree of flexibility provided to determine the parameters in terms of investment strategies. They can be set by the individual investor, e.g.: as asset class based, risk-based, ethically-based, sector-based, etc. in the form of inclusion, exclusion, overweight, underweight and portfolio tilt (e.g. over portfolio exposure), or they can be a generic/system set of parameters along similar lines. A portfolio manager module 210 determines a combined investment strategy for the combined portfolio of the investment choices of a plurality of the individual investors 50. This could be all of the individual investors 50 or a subset of the individual investors 50. A broker module 220 is in charge of executing trades and determines a cost of an investment strategy of the portfolio manager module 210. A custodian account holder module 230 operates as a trusted intermediary between the portfolio manager module 210 and the broker module 220. The trades are traditional buy/sell & long/short instructions determined by the portfolio management system 200 based on the individual investor profile/parameters/strategy.

Let us now assume that the portfolio management system 200 has a plurality of financial instruments {ƒ} in the investment universe Ω and operates a strategy s_{i,p} for participating ones of the plurality of the individual investors 50 p. We know that p ∈ [1, ∞], where i ∈ [1, ∞) is a counter used to denote possibly multiple strategies for the same ones of the individual investors p and is calculations as follows. The amount of investment A_{i,p}; for each ƒ ∈ Ω, two weights w_{ƒ,+}^{i,p}, w_{ƒ,-}^{i,p}, with 0≤w_{ƒ},^{i,p}_{{+,-}}≤1, correspond to positive (i.e., “long”) and negative (i.e., “short”) fund allocation to a specific one of the financial instruments ƒ. A weight of 0 implies that the individual investor p does not wish to invest in the financial instrument ƒ. Note that as part of the same strategy s_{i,p}, the individual investor p cannot have both negative and positive exposure for the same financial instrument ƒ (at the same epoch u). I.e., if w_{ƒ,+}^{i,p}/=0, then w_{ƒ,-}^{i,p}=0, and vice versa. It must hold that

$${\sum }_{f ∈ Ω} {w}_{f , +}^{i , p} + {\sum }_{f ∈ Ω} {w}_{f , -}^{i , p} = 1 ;$$

the volatility σ_{i,p} of the strategy.

For each ones of the financial instruments ƒ, the broker module, which is in charge for the Application Programming Interface (API) connectivity between portfolio management system 200 and a chosen broker e.g. Morgan Stanley, specifies a fraction m_{ƒ}∈ (0,1) of the financial instruments notional which should be kept in reserve to cover the risk of an adverse price move in the financial instrument. This is referred to as margin requirement for the financial instrument ƒ. For simplicity, it will be assumed that m_{ƒ} remains constant throughout the execution of a trade in the financial instrument, once the trade is specified by the broker. A change to any of the individual investors' strategies on the portfolio management system 200 can be introduced at any time t, whereas updates of the fund's strategy, upon which all of the trades are executed, occur at discrete time points tᵤ, u ∈ [1, ∞].

The period between two subsequent updates of the fund strategy is called an epoch 10, i.e., the u-th epoch occurs between tᵤ₋₁,tᵤ. When referring to trades for epoch u, these trades are executed at time tᵤ. The time points tᵤ are not necessarily fixed ahead of time. As explained above, these epochs may be triggered by a variety of events, investor, manager, or market related.

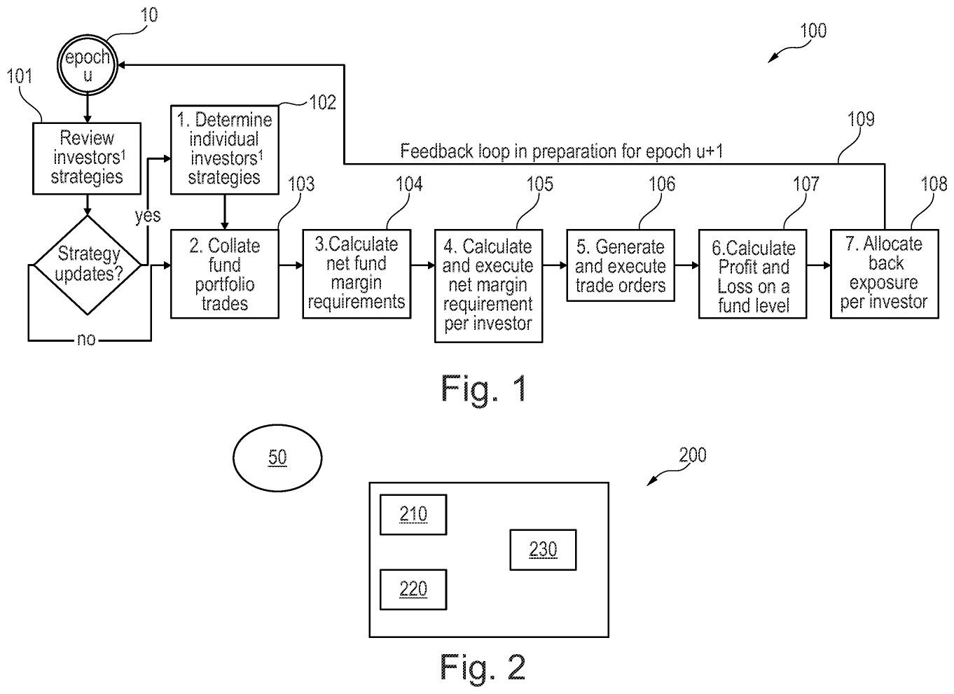

FIG. 1 shows a flowchart of the method 100 for management of an investment portfolio strategy for the plurality of individual investors 50 in a fund according to the first aspect of the present invention using the portfolio management system 200. In step 101, the method reviews the strategy of the individual investor of the plurality of investors by a portfolio manager module 210. The method 100 evaluates the expected performance (i.e., including costs) of the strategy of a single one of the individual investors in the context of a portfolio with many participating investors. After reviewing the strategy of the individual investor, in step 102, the method determines an individual strategy for the individual investor by the portfolio manager module 210. The step 102 is executed by the portfolio manager module 210 in order to produce the investment strategy weights for the individual investor. The portfolio manager module 210 takes inputs from the individual investor p (in practice, this may only involve affected ones of the individual investors: for simplicity, it will be assumed that all of the individual investors are affected) including volatility level σ_{i,p}, investment amount A_{i,p}, and investor profile preferences, for latest strategy i. The step 102 determines a weight of stocks {w_{ƒ}^{i,p}(t)} for each ƒ ∈ Ω that is consistent with investor's p input. These output weights are then used to formulate the investor's strategy s_{i,p}(t) at a time t, consisting of the weights, the volatility level and the investment amount, as explained above.

The method 100 further processes the determined individual strategy for the individual investor. The portfolio manager module 210 collates net fund portfolio trades in step 103. The net fund portfolio trades represent the total trades for all its investors. Individual investors at any given point in time may have opposite exposures (trades) due to their personal investment profile (e.g. one investor may want to go long $150 of a share and at the same moment another investor may want to short $100 of the same share. The ‘net fund portfolio trade’, assuming no other investor trades the same share at that same moment (epoch), will thus be Buy $50 of the same share. The step 103 is performed by the portfolio manager module 210 and calculates the overall trades to be executed within the portfolio for the epoch u, i.e. the period between two subsequent updates of the fund strategy, i.e., the u-th epoch occurs between tᵤ₋₁,tᵤ, when referring to trades for the epoch u, these are executed at time tᵤ.

The step 103 combines the strategies s_{i,p}(t) of the individual investors, output by the previous step for all t in epoch u (i.e., tᵤ₋₁<t≤tᵤ) into the fund's set of trades for epoch u,K(u). This effectively enables replacement of the simultaneous optimization of the multiple portfolios (for individual investors) by the optimization of the overall portfolio, conditioned on a current state of the overall portfolio.

For implementation purposes, the output of the step 103 may be represented as a simple “map” function ƒ→w_{ƒ}^{i,p} and can thus be implemented within the standard mapreduce framework [Jeffrey Dean and Sanjay Ghemawat. MapReduce: simplified data processing on large clusters. Commun. ACM, 51 (1):107-113, 2008]. First, the following is defined:

$${A}_{f , +}^{fund} ( u ) = {\sum }_{i , p} {A}_{i , p} ( u ) {w}_{f , +}^{i , p} ( u ) \\ {A}_{f , -}^{fund} ( u ) = {\sum }_{i , p} {A}_{i , p} ( u ) {w}_{f , -}^{i , p} ( u )$$

Based on the above, the net exposure per financial instrument can be now defined at epoch u as A_{ƒ}^{fund}(t), and calculated as

$${A}_{f}^{fund} ( u ) = {A}_{f , +}^{fund} ( u ) - {A}_{f , -}^{fund} ( u )$$

In step 103, collectively, these A^{fund}_{ƒ}(u) are the funds trade strategy for the epoch u. In order to deduce the trades in the financial instruments necessary for implementing this funds trade strategy, for each ƒ the differential from its net exposure from epoch u−1 needs to be considered. The net exposure effectively means profit/loss from the previous epoch, as a math formula it would be A fund/ƒ (−u−1). For each ƒ ∈ Ω, the set of trades K_{ƒ}(u) that need to be executed at the epoch u is defined as K_{ƒ}(u)={K_{ƒ},+(u),K_{ƒ},−(u)}. A positive K_{ƒ},+(u) (respectively K_{ƒ},−(u)) corresponds to buying a “long” (respectively a “short) position of value K_{ƒ},+(u) (respectively K_{ƒ},−(u)). Likewise, a negative value corresponds to selling a “long” (respectively “short) position. K_{ƒ}(u) is computed as:
(a) If A_{ƒ}^{fund}(u)·A_{ƒ}^{fund} (u−1)<1
i. If A_{fund}^{ƒ}(u)<0 then K_{ƒ}(u)={K_{ƒ},+(u),K_{ƒ},(u)}={−A_{fund}^{ƒ}(u−1) . . . A_{ƒ}^{fund}(u)}, i.e., two trades where one trade closes the position from the previous epoch u−1 (selling the previous “long”) and the other trade purchases A_{ƒ}^{fund}(u) value of “short” position for ƒ.
ii. Else, if A_{ƒ}^{fund}(u)>0 then K_{ƒ}(u)={K_{ƒ},+(u),K_{ƒ},−(u)}={A_{ƒ}^{fund}(u . . . 1),A_{ƒ}^{fund}(u), i.e., two trades where one trade purchases. A_{fund}^{ƒ}(u) value of “long” position for ƒ, and the other trade closes the position from the previous epoch u−1 (selling the previous “short”).
(b) Else, denote the differential for ƒ as D_{ƒ}(u)=|A_{ƒ}^{fund}(u)−A_{ƒ}^{fund}(u−1)|.
i. If A_{ƒ}^{fund}(u),A_{ƒ}^{fund}(u−1)≥0 then K_{ƒ}(u)={D_{ƒ}(u),0}, i.e., a single trade buying the differential between the two epochs in the “long” position.
ii. Else, if A_{fund}^{ƒ}(u),A_{fund}^{ƒ}(u−1)≤0 then K_{ƒ}(u)={0,D_{ƒ}(u)}, i.e., a single trade buying the differential between the two epochs in the “long” position.

It is noted that a zero-trade value corresponds to no trade for the corresponding position in the financial instrument. The set K^{fund}(u)={K_{ƒ}(u)}_{ƒ∈Ω} is the set of trades to be executed for the entire fund at the end of the epoch u.

The portfolio manager module 210 further calculates net fund margin requirements in combination with a broker module 220 in step 104. The step 104 is performed by the portfolio manager module 210, in combination with the broker module 220. For the financial instrument ƒ, the broker module 220 sets a margin requirement mf corresponding to the percentage of the net amount of the financial investments. For simplicity, it is assumed that my remains constant once specified by the broker module 220. The net margin requirement for the financial instrument ƒ at the epoch u is computed as K_{ƒ},−(u)·m_{ƒ} and the total margin requirement for the fund is computed as ^{P}_{ƒ∈Ω}K_{ƒ},−(u)·m_{ƒ}. Note that for “long” investments it is assumed that the margin requirement equals the entire notional for ƒ i.e., the corresponding m_{ƒ}=1, in order to accommodate the stock purchase. The total amount to be transferred to (or from) the broker module 220 is thus computed as

$${T}_{u}^{fund} = {\sum }_{f ∈ Ω} {K}_{f , +} ( u ) + {\sum }_{f ∈ Ω} {K}_{f , -} ( u ) \cdot {m}_{f} - C ,$$

where C is computed as

$$C = {ExpectedValue}_{u} ( {\sum }_{f ∈ Ω} {K}_{f , -} ( u - 1 ) ) - {Value}_{u - 1} ( {\sum }_{f ∈ Ω} {K}_{f , -} ( u - 1 ) )$$

i.e., the difference of the expected value of the portfolio's positions from the previous epoch u−1 at the current epoch u, based on the execution prices at the time u−1. It is assumed that the value of the positions from the time u−1 is taken “in expectation” as the trades in the financial instruments have not yet been executed: in practice, there will be a small-time difference between the evaluation of this step and the execution of the trades.

In a further step 105, the portfolio manager module 210 further calculates and executes net margin requirements per individual investor in combination with a custodial account holder module 230. The step 105 is performed by the portfolio manager module 210 and the participating individual investors' accounts, in combination with the custodian account holder 230. The goal is to source and allocate the required funds Tᵤ^{fund} for the transactions to be executed at the epoch u from the individual investor accounts to the custodian account (e.g., via an intermediary fund account). It is assumed that an existing source algorithm is agreed as part of the portfolio parameters. For instance, this sourcing algorithm could be uniform sourcing, or weighted per financial instrument ƒ, weighted per individual investment amounts, etc. Once this sourcing process is concluded, the funds are transferred between the investor accounts and the fund account, according to the process's output, and from there to the custodian account holder module 230. Finally, this transfer corresponds only to “outgoing” cash flows from the investors' accounts to the fund account. Cases where the funds are returned and allocated to the individual investors' accounts take place after the execution of the trade at the next step.

In step 106, the broker module 220 generates and executes the trade orders. The step 107 is performed by the broker module 220, executing the trade orders for the epoch u after the funds have been made available at the custodian holder account module 230. The following cases are to be considered:
(a) For each “buy” trade, the broker module 220 executes the corresponding transaction for the fund's purchase of N_{ƒ,u} units of the financial instrument ƒ, where

$${N}_{f , u} = \frac{{K}_{f , +} ( u ) - {τ}_{f , u} - {ℓ}_{f , u}}{{P}_{f , u}}$$

P_{ƒ,u} is the executed unit price of the financial instrument ƒ at time tᵤ and T_{ƒ,u} is the brokerage cost for ƒ (for simplicity, it is assumed that trade execution is “actualized” at time tᵤ). For “buy short” trades, the ′ƒ,u term corresponds to the daily lending cost of the stock, appropriately modified to account for the epochs' duration (e.g., some intra-daily epochs may not incur such costs, whereas others may incur the costs multiple times).
(b) For each “sell” trade, the broker module 220 executes the corresponding transaction, selling a number of units of ƒ computed as

$${N}_{f , u} = \frac{- {K}_{f , +} ( u ) - {τ}_{f , u}}{{P}_{f , u}}$$

As a result of this, for “long” trades, −K_{ƒ},+−tᵤ is credited into the account in cash. For “short trades” the amount that is credited to the custodian holder account module 230 is

$$( {P}_{f , {u}^{′}} - {P}_{f , u} ) \cdot {N}_{f , u} - {τ}_{f , {u}^{′}} - {τ}_{{f}_{u}} - {\sum }_{{u}_{i} = 0}^{{u}^{′} - u} {ℓ}_{f , {u}^{′} + {u}_{i}}$$

where the corresponding “buy” trade was initiated at the epoch u. In the above, it is assumed that fractional shares can be traded.

In step 107, the method calculates the expected profit/loss. After the execution of the trades, the profit and loss on a fund level can be calculated, as follows. For each financial instrument ƒ with nonzero position at a time tᵤ, let S_{ƒ}={y₁, . . . ,y_{|Sƒ|}} be a set of executed transactions from which it consists. For notation purposes, transaction yᵢ was executed at the epoch uᵢ≤u, involving N_{ƒ,ui} units of ƒ, at price P_{ƒ,ui}. The current state of ƒ in the portfolio can now be computed as

$${B}_{f , u} = {\sum }_{i = 1}^{\vert {S}_{f} \vert} [ {N}_{f , {u}_{i}} \cdot ( P ( f , u ) - P ( f , {u}_{i} ) ) ]$$

The overall state of the portfolio at the end of the epoch u is computed as

$${B}_{u}^{fund} = {\sum }_{f ∈ Ω} {B}_{f , u}$$

In step 107, the method 100 allocates profit/loss at a fund level. In step 108, the method 100 allocates profit/loss per individual investor. The steps 107 and 108 are performed internally between the portfolio manager module 210 and the individual investors' accounts. The goal is to allocate the acquired investment units per financial instrument ƒ back to the individual investors that are involved in the financial instrument ƒ, as exposure for the epoch u. This is achieved via a function executed for each user p (i.e. the individual investor), strategy i, and the financial instrument ƒ, taking as input parameters:
p,i,ƒ triplet
exposure weight w_{ƒ},^{i,p}_{{+,-}}(u) as requested by the investor's strategy (step 2)
achieved trade price P_{ƒ,u}
as brokerage and (possibly) daily lending costs τ_{ƒ,u},′_{ƒ,u}(step 5)

The function's final output for each p,i,ƒ triplet is a modified weight w\hat{ }_{ƒ},^{i,p}_{{+,-}}(u) for user p, achieved at price P_{ƒ,u}. Based on this, the achieved exposure for p,i,ƒ at epoch u is A_{i,p}(u)·w_{ƒ,{+,-}}^{i,p}(u).

The above description comprises all the portfolio management steps executed for the epoch u. As the present system/method is slotted per epoch, the above process is repeated indefinitely, updating the portfolio investment strategy while the portfolio is managed by providing the method step 109 of a feedback loop in preparation for epoch u+1. The feedback loop step 109 is the ability of the present method to re-run the previous performed steps (steps 101 to 108), where each re-run adds new (useful) material, for example: new data, new users, adjustment on the investment strategy of current users (risk level, ethos profile, exposure), adding of new assets and new strategies to the existing store of data being used to perform the steps.

In a further step, the method 100 applies money market transactions. The method 100 further comprises a step in which the margin requirements for all investors in the fund are recalculated and re-allocated dynamically and at arbitrary times due to changes in their investment strategy or external market events. Therefore, the method 100 can dynamically recalculate and re-allocate the margin requirements for the participating individual investors in the fund. These margin requirements may change as a consequence of four different events. In a first event, any one of the individual investors makes a change in their investment strategy (i.e., change risk preference, increase/decrease allocation on their strategy, or introduce new trades). This may take place at arbitrary times, it may potentially impact all participants, and the effect on the portfolio should be immediate. In a second event, market events that trigger increase or decrease of the margin requirements (e.g., margin calls) of the entire portfolio. Such events impact all participants and can take place at arbitrary times. In a third event, trades that are systematically introduced to the fund by the portfolio manager as a result of the alpha generation signals (investment strategies). These events take places periodically in discrete epochs, e.g., intra-daily, daily, weekly. In a fourth event, model changes applied to the system by the portfolio manager, e.g., due to strategy adjustments or new actionable information about the cost of trading.

The method 100 further comprises a step, in which the margin requirements for all or some of the individual investors in the fund are recalculated and re-allocated dynamically after the model changes and the market trades performed by the fund manager. In further step, the method 100 keeps track of all system changes.

FIG. 2 shows the system 200 for management of an investment portfolio strategy for the plurality of investors 50 in the fund according to the second aspect of the present invention. The system comprises a portfolio manager module 210, a broker module 220, and a custodial account holder module 230. The portfolio manager 210 reviews the strategy of the individual investor of the plurality of investors. The portfolio manager module 210 determines an individual strategy for the individual investor and processes the determined individual strategy for the individual investor. The portfolio manager module 210 collates net fund portfolio trades calculates net fund margin requirements in combination with the broker module 220 and the portfolio manager module 210 calculates and executes net margin requirements per investor in combination with the custodial account holder module 230. The broker module 220 generates and executes trade orders, and the investment portfolio strategy system 200 calculates the expected profit/loss.

The system 200 is further configured such that the portfolio manager module 210 allocates profit/loss at a fund level. The system 200 is further configured such that the portfolio manager module 210 allocates profit/loss per investor. The system 200 is further configured such that the portfolio manager module 210 applies money market transactions.

The system 200 is further configured such that the portfolio manager module 210 recalculates and re-allocates the margin requirements for the investors in the fund dynamically and at arbitrary times due to changes in their investment strategy or external market events. The system 200 is further configured such that the portfolio manager module 210 recalculates and re-allocates the margin requirements for the investors in the fund dynamically after model changes and market trades performed by the fund manager. The system 200 is further configured such that system 200 keeps tracking of all system changes.

While merely a number of selected aspects have been chosen to describe the present method and system, persons skilled in the art will understand on the basis of this disclosure that various changes and modifications can be effected here without deviating from the scope of the invention as defined in the attached claims.

1. A method for management of an investment portfolio strategy for a plurality of investors in a fund, comprising the steps of:
reviewing the strategy of an individual investor of the plurality of investors by a portfolio manager module;
determining an individual strategy for the individual investor by the portfolio manager module;
processing the determined individual strategy for the individual investor;
collating net fund portfolio trades by the portfolio manager module;
calculating net fund margin requirements by the portfolio manager module in combination with a broker module;
calculating and executing net margin requirements per investor by the portfolio manager module in combination with a custodial account holder module;
generating and executing trade orders by the broker module; and
calculate the expected profit/loss.

2. The method according to claim 1, further comprising providing a feedback loop.

3. The method according to claim 1, further comprising allocating profit/loss at a fund level.

4. The method according to claim 1, further comprising allocating profit/loss per investor.

5. The method according to claim 1, further comprising applying money market transactions.

6. The method according to claim 1, further comprising recalculating and re-allocating the margin requirements for investors in the fund dynamically and at arbitrary times due to changes in one of investment strategy or external market events.

7. The method according to claim 1, further comprising recalculating and re-allocating the margin requirements for investors in the fund dynamically after model changes and market trades performed by the fund manager.

8. The method according to claim 1, further comprising keeping track of system changes.

9. An investment portfolio strategy system for management of an investment portfolio strategy for a plurality of investors in a fund, comprising:
a portfolio manager module for reviewing a strategy of an individual investor of a plurality of investors, wherein the portfolio manager module is adapted to:
determine an individual strategy for the individual investor and processes the determined individual strategy for the individual investor;
collate net fund portfolio trades;
calculate net fund margin requirements in combination with a broker module; and
calculate and execute net margin requirements per investor in combination with a custodial account holder module
wherein the broker module is adapted to generate and execute trade orders; and wherein the investment portfolio strategy system is adapted to calculate the expected profit/loss.

10. The system according to claim 9, wherein the portfolio manager module is adapted to allocate profit/loss at a fund level.

11. The system according to claim 9, wherein the portfolio manager module is adapted to allocate profit/loss per investor.

12. The system according to claim 9, wherein the portfolio manager module is adapted to apply money market transactions.

13. The system according to claim 9, wherein the portfolio manager module is adapted to recalculate and re-allocate the margin requirements for investors in the fund dynamically and at arbitrary times due to changes in their investment strategy or external market events.

14. The system according to claim 9, wherein the portfolio manager module is adapted to recalculate and re-allocate the margin requirements for investors in the fund dynamically after model changes and market trades performed by the fund manager.

15. The system according to claim 9, wherein the system is adapted to track of system changes.
